(19) United States
(12) Patent Application Publication
(10) Pub. No.: US 2009/0102754 A1
(43) Pub. Date: Apr. 23, 2009

(54) PLASMA DISPLAY DEVICE AND METHOD THEREOF

(75) Inventors: Jae-Kwang LIM, Suwon-si (KR); Heung-Sik TAE, Daegu (KR)

Correspondence Address: STEIN, MCEWEN & BUI, LLP, 1400 EYE STREET, NW, SUITE 300, WASHINGTON, DC, 20005, US

(73) Assignees: Samsung SDI Co., LTD., Suwon-si (KR); Industry-University Cooperation Foundation Kyungpook National University, Daegu (KR)

(21) Appl. No.: 12/250,779

(22) Filed: Oct. 14, 2008

(30) Foreign Application Priority Data
Oct. 23, 2007 (KR) 2007-106769

(51) Int. Cl. G09G 3/28

(52) U.S. Cl. 345/60

(57) ABSTRACT

A method for driving a single frame of a plasma display device, the frame including a plurality of subfields, and each subfield including a reset period, an address period, and a sustain period. The method shortens an increasing time of at least one sustain pulse including the last sustain pulse among a plurality of sustain pulses, to be supplied to the sustain period of the respective subfields, and lengthens the increasing times of the rest of the sustain pulses.

### CROSS-REFERENCE TO RELATED APPLICATION

This application claims the benefit of Korean Patent Application No. 2007-106769, filed on Oct. 23, 2007, in the Korean Intellectual Property Office, the content of which is incorporated herein by reference.

### BACKGROUND OF THE INVENTION

1. Field of the Invention

An aspect of the present invention relates to a plasma display device and a method thereof, and more particularly, to a plasma display device for preventing delay of an address signal and a method of driving the same.

2. Description of the Related Art

A plasma display device is a device utilizing a plasma display panel (PDP) for displaying text and an image using plasma generated by gas discharge. The plasma display device includes the PDP for implementing an image and a plurality of driving circuits for driving the PDP.

In the plasma display panel device, a discharge space defined between a scan electrode and a sustain electrode or between a surface on which an address electrode is formed and a surface on which the sustain electrode is formed in the PDP functions as a capacitive load to generate capacitance in the PDP.

The capacitance of the PDP varies by screens due to the variation of load caused by a displayed image. Particularly, the capacitance of the PDP is increased as an effective display area of the PDP on which an actual image is displayed is increased. Due to this, a signal is delayed and a waveform of a sustain pulse may be distorted. The distortion of the sustain pulse affects discharge and may change the amount of wall charges.

For example, when the capacitance is increased due to the increase of the load due to the increase of the effective display area, the distortion of the sustain pulse may bring insufficient discharge for a sustain period. In this case, a correct brightness cannot be displayed for a time period when the discharge is generated by the distorted sustain pulse. Moreover, the amounts of wall charges accumulated on the respective electrodes are also affected so that the address signal of a subfield may be delayed.

As such, when the address signal is delayed, the generated discharge is not as desired for an address period and the wall charges for the address are not generated well.

Therefore, since the sufficient discharge does not occur for the following sustain period, there may be a problem expressing uniform grays in every image, thereby decreasing the brightness.

### SUMMARY OF THE INVENTION

Accordingly, it is an aspect of the present invention to provide a plasma display device for preventing an address signal from being delayed and a method of driving the same.

According to another aspect of the present invention, there is provided a plasma display device driving method of driving a single frame of the plasma display, the single frame divided into a plurality of subfields, each subfield including a reset period, an address period, and a sustain period, the method including: shortening an increasing time of at least one sustain pulse including the last sustain pulse among a plurality of sustain pulses, to be supplied at the sustain period, and lengthening an increasing time of the rest of sustain pulses.

According to another aspect of the present invention, a main reset pulse, including a reset ascending period and a reset descending period, among the plurality of subfields is supplied at a reset period of a first subfield, and an auxiliary reset pulse, having a maximum voltage level lower than a maximum voltage level of the main reset pulse and including the reset descending period, is supplied to at least one reset period among the rest subfields followed by the first subfield. The increasing time is adjusted by adjusting a switching timing of a sustain discharging circuit for generating at least one sustain pulse including the last sustain pulse. The switching timing is set such that a duration of a switching pulse to be supplied for at least one sustain pulse including the last sustain pulse is shorter than a duration of a switching pulse to be supplied to the ascending period of the rest of the sustain pulses. The sustain pulse whose increasing time decreases comprises one to four sustain pulses to be sequentially supplied, including the last sustain pulse.

According to another aspect of the present invention, there is provided a method of driving a plasma display device including: determining an address pulse in response to an image signal; estimating a ratio of an effective display area corresponding to the address pulse; controlling a driving timing signal of a sustain discharging circuit for generating the sustain pulse based on the ratio of the effective display area; and generating the sustain pulse in response to the driving timing signal; wherein the driving timing signal is controlled to decrease the increasing time of at least one sustain pulse including the last sustain pulse to be supplied to the sustain period, as the ratio of the effective display area increases.

According to another aspect of the present invention, the controlling of the driving timing signal of the sustain discharging circuit includes: selecting at least one mode among predetermined modes by comparing the estimated ratio of the effective display area with a reference ratio of the effective display area; and generating the driving timing signal of the sustain discharging circuit based on the selected mode. The driving timing signal of the sustain discharging circuit comprises a switching pulse for controlling turning on/off a plurality of switches included in the sustain discharging circuit. The duration of the switching pulse of the sustain discharging circuit to be supplied for the ascending period of the at least one sustain pulse including the last sustain pulse is set to be short at a mode where the ratio of the effective display area corresponds to a relative large value, among the modes. The sustain pulse whose increasing time decreases comprises one to four sustain pulses to be sequentially supplied, including the last sustain pulse. The ratio of the effective display area is estimated based on the number of the address pulses.

According to still another aspect of the present invention, there is provided a plasma display device including: a plasma display panel including a plurality of address electrodes, and discharge cells formed at places where scan electrodes and sustain electrodes cross the address electrodes; a driving unit for driving the address electrodes, the scan electrodes, and the sustain electrodes; and a controller for supplying a control signal to the driving unit in response to an image signal supplied from the outside, wherein the controller estimates a ratio of an effective display area of an entire display area of the plasma display panel in response to the image signal and generates a control signal for controlling sustain pulses, generated by the driving unit, to be adjusted in response to the ratio of the effective display area.

According to another aspect of the present invention, the control signal is controlled to decrease the increasing time of at least one sustain pulse including the last sustain pulse of respective subfields, among sustain pulses generated by the driving unit as the ratio of the effective display area increases. The ratio of the effective display area is estimated based on the number of the address pulses. The driving unit includes: an address electrode driving unit for driving the address electrodes; a scan electrode driving unit for driving the scan electrodes; and a sustain electrode driving unit for driving the sustain electrodes; and the scan electrode driving unit or the sustain electrode driving unit comprises a sustain discharging circuit whose driving timing is adjusted by the control signal. The driving timing of the sustain discharging circuit is controlled to decrease a duration of pulses to be supplied for an ascending period of at least one sustain pulse including the last sustain pulse among sustain pulses generated for the sustain period of the respective subfields as the ratio of the effective display area increases.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a general structure of a plasma display panel (PDP) to which an embodiment of the present invention is applied;

FIG. 2 is a circuit diagram schematically illustrating a configuration of a plasma display device of an embodiment of the present invention;

FIG. 3 is a view illustrating driving pulses that are supplied to respective electrodes of a PDP by a method of driving the plasma display device according to an embodiment of the present invention;

FIG. 4A is a view illustrating an increase of an effective display area of an entire display area of the PDP;

FIG. 4B is a view illustrating variation of power consumption and current with the increase of the effective display area;

FIG. 4C is a view illustrating variation of a time constant and capacitance of the PDP with the increase of the effective display area;

FIG. 5A is a view illustrating the amounts of sustain pulses and infrared rays emitted from an X-electrode and a Y-electrode with ratios of the effective display area of 10%, 50%, and 100%, respectively;

FIG. 5B is a view illustrating the amount of emitted infrared rays that is measured for an address period of one subfield;

FIG. 6 is a view illustrating driving pulses supplied to the respective electrodes of the PDP by the method of driving a plasma display device according to another embodiment of the present invention;

FIG. 7 is a view illustrating an example of a sustain discharging circuit;

FIG. 8 is a view illustrating driving waveforms for driving the sustain discharging circuit of FIG. 7 according to another embodiment of the present invention;

FIG. 9 is a flowchart illustrating the method of driving a plasma display device according to another embodiment of the present invention;

FIG. 10 is a view illustrating the amount of emitted infrared rays according to an adjustment of increasing time of the last sustain pulse; and

FIG. 11 is a view illustrating a delay of an address signal based on the ratio of the effective display area according to the adjustment of the increasing time of the last sustain pulse.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, certain exemplary embodiments of the present invention will be described with reference to the accompanying drawings. Here, when a first element is described as being coupled to a second element, the first element may not only be directly coupled to the second element but may also be indirectly coupled to the second element via a third element. Further, elements that are not essential to the complete understanding of the invention are omitted for clarity. Also, like reference numerals refer to like elements throughout.

FIG. 1 illustrates a general structure of a plasma display panel (PDP) to which an embodiment of the present invention is applied.

Referring to FIG. 1, the PDP 100 is configured such that a front panel 10 and a rear panel 20 are coupled and parallel to each other, and are separated by a predetermined distance forming a space therebetween. The front panel 10 is configured such that a plurality of sustain electrode pairs made of pairs of scan electrodes 12 and sustain electrodes 13 are arranged in a front substrate 11 as a display surface on which an image is displayed. In the rear panel 20, a plurality of address electrodes 23 are arranged on a rear substrate 21 forming a rear surface to cross the plurality of sustain electrode pairs.

The front panel 10 includes plural pairs of the scan electrodes 12 and the sustain electrodes 13 to mutually discharge in a single discharge cell and to maintain light emission of the cell. Here, each of the scan electrodes 12 and the sustain electrodes 13 includes transparent electrodes 12a and 13a made of indium-Tin oxide (ITO) and bus electrodes 12b and 13b made of metal. The scan electrodes 12 and the sustain electrodes 13 are covered with one or more upper dielectric layers 14 for restricting discharge current and insulating between the electrode pairs. On a lower side of the upper dielectric layer 14, a protecting layer 15 is formed, the protective layer 15 being deposited with magnesium oxide to make a discharging condition easy.

The rear panel 20 includes partitions 22 arranged in parallel in the strife type (or well type) such that a plurality of discharge spaces, that is, discharging cells are formed, and a plurality of address electrodes 23 arranged in a parallel direction relative to the upper partitions 22 perform address discharge to generate vacuum infrared rays. Between the upper partitions 22 of the rear panel 20, R-, G-, and B-phosphors are coated to display an image during the address discharge. In this case, between the address electrodes 23 and the phosphors 24, a lower dielectric layer 25 is formed to protect the address electrodes 23.

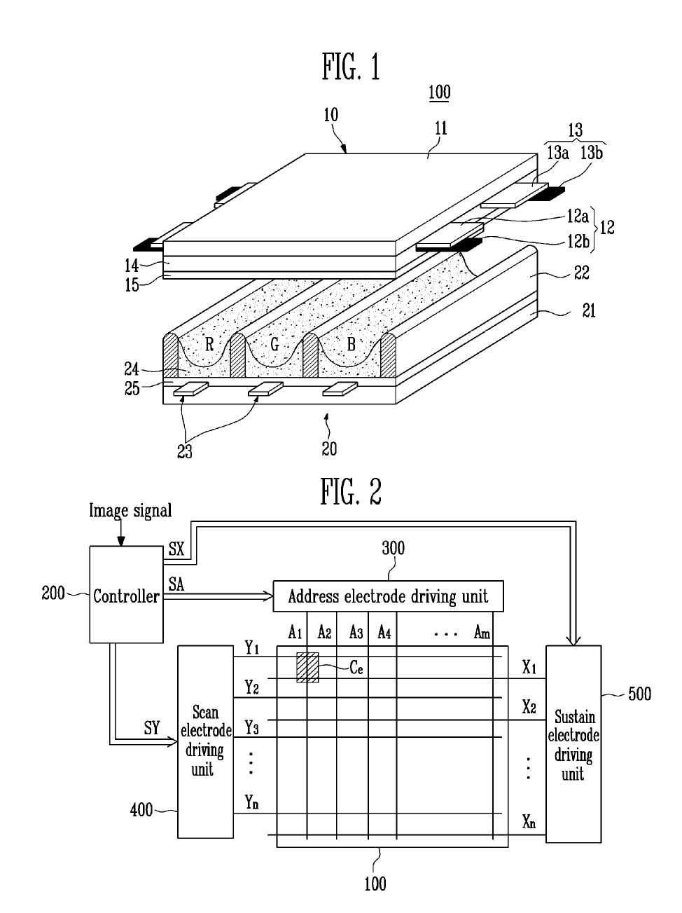

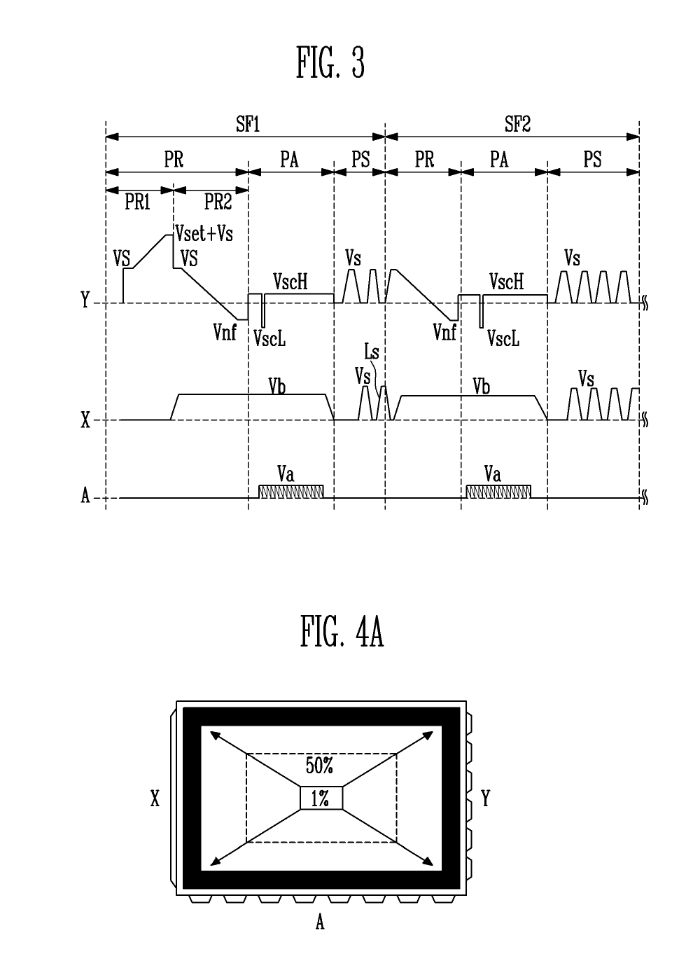

FIG. 1 illustrates the R-, G-, and B-discharge cells forming a single pixel for convenience of explanation. However, a plurality of discharge cells are arranged in the PDP 100 in the form of a matrix. The discharge cells are formed at places where the scan electrodes and the sustain electrodes cross the address electrodes. This detail will be described with reference to FIG. 2 later.

FIG. 2 is a circuit diagram schematically illustrating a configuration of the plasma display device according to the embodiment of the present invention.

Referring to FIG. 2, the plasma display device according to the embodiment of the present invention includes a plasma display panel (PDP) 100, a controller 200, an address electrode driving unit 300, a scan electrode driving unit 400, and a sustain electrode driving unit 500.

The PDP 100 includes a plurality of address electrodes Al to Am arranged in a column direction, a plurality of scan electrodes Y1 to Yn and sustain electrodes X1 to Xn that are arranged in a row direction to form pairs, and discharge cells Ce formed at places where the scan electrodes and the sustain electrodes cross each other to form unit pixels.

The controller 200 generates an address electrode driving control signal SA, a scan electrode driving control signal SY, and a sustain electrode driving control signal SX, in response to an image signal received from the outside, and supplies the same to the address electrode driving unit 300, the scan electrode driving unit 400, and the sustain electrode driving unit 500, respectively. The controller 200 divides a single frame into a plurality of subfields, and drives each of the subfields for a reset period, an address period, and a sustain period, individually.

The address electrode driving unit 300 generates a display data signal for selecting a discharge cell Ce to be displayed in response to the address electrode driving control signal SA supplied from the controller 200, and supplies the same to the respective address electrodes A1 to Am. The address electrode driving unit 300 includes a plurality of driving circuits to generate the display data signal in response to the address electrode driving control signal SA.

The scan electrode driving unit 400 includes a plurality of driving circuits to supply driving pulses to the scan electrodes Y1 to Yn in response to the scan electrode driving control signal SY supplied from the controller 200.

The sustain electrode driving unit 500 includes a plurality of driving circuits to supply driving pulses to the sustain electrodes X1 to Xn in response to the sustain electrode driving control signal SX supplied from the controller 200.

FIG. 3 is a view illustrating the driving pulses that are supplied to the respective electrodes of the PDP using a method of driving the plasma display device according to an embodiment of the present invention. For convenience of explanation, FIG. 3 illustrates only two subfields of the plurality of subfields, the two subfields are called a first subfield and a second subfield.

Referring to FIG. 3, each of the first and second subfields SF1 and SF2 includes a reset period PR, an address period PA, and a sustain period PS.

Here, main reset pulses including a reset ascending period PR1 and a reset descending period PR2 are supplied to the first subfield SF1 of the reset period PR. The reset period of the following subfields (not shown) including the second subfield SF2 uses a selective reset method of supplying auxiliary reset pulses. However, an aspect of the present invention is not limited to these pulses, but various types of reset pulses may be supplied to the reset period PR or main reset pulses may be repeatedly supplied without the auxiliary reset pulses.

The first subfield SF1 represents low gray subfields as subfields with the lowest gray weight among the plurality of subfields. The second subfield SF2 represents high gray subfields with a gray weight higher than the first subfield SF1. Therefore, the number of sustain pulses to be supplied to the sustain period PS of the second subfield SF2 is greater than the number of sustain pulses to be supplied to the sustain period PS of the first subfield SF1.

In the description with reference to FIG. 3, the scan electrodes, the sustain electrodes, and the address electrodes are called Y-electrodes, X-electrodes, and A-electrodes, respectively.

For the reset ascending period PR1 of the first subfield SF1, ascending pulses are supplied to increase Vs voltage as much as Vset to the Y-electrodes while maintaining voltages of the X-electrode and the A-electrodes at 0 (zero) voltage. By doing so, weak reset discharge is generated between the Y-electrode and the X-electrodes and between the Y-electrodes and the A-electrodes so that minus polarity wall charges are accumulated on the Y-electrodes and plus polarity wall charges are accumulated on the X-electrodes and the A-electrodes.

After that, for the reset descending period PR2 of the first subfield SF1, descending pulses are supplied to decrease a Vs voltage to a Vnf voltage while maintaining voltages of the X-electrode and the A-electrodes at Vb voltage and 0 (zero) voltage, respectively. By doing so, weak reset discharge is generated between the Y-electrode and the X-electrodes and between the Y-electrodes and the A-electrodes so that some of the minus polarity wall charges that are accumulated on the Y-electrodes is eliminated and some of the plus polarity wall charges that are accumulated on the X-electrodes and the A-electrodes is eliminated. At this time, a wall voltage caused by the wall charges is formed as a voltage in the vicinity of a discharge starting voltage. The main reset pulses including the ascending pulses and the descending pulses are supplied to entire discharge cells simultaneously so that the wall charges are rearranged, thereby generating the address discharge when scan pulses and data pulses are supplied.

After that, in order to maintain the Vb voltage of the X-electrodes, scan pulses with VscL voltage and address pulses with Va voltage are supplied to the Y-electrodes and the A-electrodes at the address period PA of the first subfield SF1 to select the discharge cells to be displayed for the sustain period PS. In other words, the address discharge is generated by the wall voltage caused by a voltage difference Va−VscL between the Y-electrodes and the A-electrodes and the wall charges. Due to this, the plus polarity wall charges are accumulated on the Y-electrodes and the minus polarity wall charges are accumulated on the A-electrodes and the X-electrodes.

After that, in order to maintain 0 voltage of the A-electrodes, sustain pulses with alternate Vs voltage are supplied to the Y-electrodes and the X-electrodes for the sustain period PS of the first subfield SF1. By doing so, the sustain discharge is generated by a voltage difference Vs between the Y-electrodes and the X-electrodes and the wall voltage generated for the address period PA. At this time, the number of the sustain pulses to be supplied to the X-electrodes and the Y-electrodes is determined based on a gray weight of the subfield. Therefore, the smallest number of the sustain pulses is supplied to the first subfield SF1 among the plurality of subfields.

When the sustain period PS of the first subfield SF1 ends, the second subfield SF2 starts.

In order to maintain Vb voltage and 0 (zero) voltage of the X-electrodes and the A-electrodes respectively, the auxiliary reset pulses are supplied to the Y-electrodes to decrease the Vs voltage to Vnf voltage. By doing so, the weak reset discharge is generated between the Y-electrode and the X-electrodes and between the Y-electrodes and the A-electrodes so that the wall charges of the Y-, X-, and A-electrodes are rearranged to generate the address discharge.

However, if the sustain discharge does not occur for the sustain period PS of the first subfield SF1, the state of the wall charges of the discharge cells remain in the state directly after the reset period PR of the first sustain period PS. Therefore, since the wall voltage is formed in the vicinity of the discharge starting voltage, the discharge does not occur for the reset period PR of the second subfield SF2 to which the auxiliary reset pulses are supplied.

Thereafter, for the address period PA of the second subfield SF2, the same pulses as the first subfield SF1 are supplied to select the discharge cells to be selected for the sustain period PS.

After that, in order to maintain 0 voltage of the A-electrodes, sustain pulses with alternate Vs voltage are supplied to the Y-electrodes and the X-electrodes for the sustain period PS of the second subfield SF2. Therefore, the sustain discharge is generated by the voltage difference Vs between the Y-electrodes and the X-electrodes and the wall voltage generated for the address period PA. Here, the second subfield SF2 has a gray weight relatively higher than that of the first subfield SF1. Due to this, the number of the sustain pulses to be supplied to the X-electrodes and the Y-electrodes is greater than the number of the sustain pulses to be supplied to the sustain period PS of the first subfield SF1.

According to the above-mentioned method of driving a plasma display device of this embodiment of the present invention, the main reset pulses are not supplied to all the subfields of the reset period, but are rather supplied to the subfields of cells where the discharge occurs, thereby improving a contrast ratio.

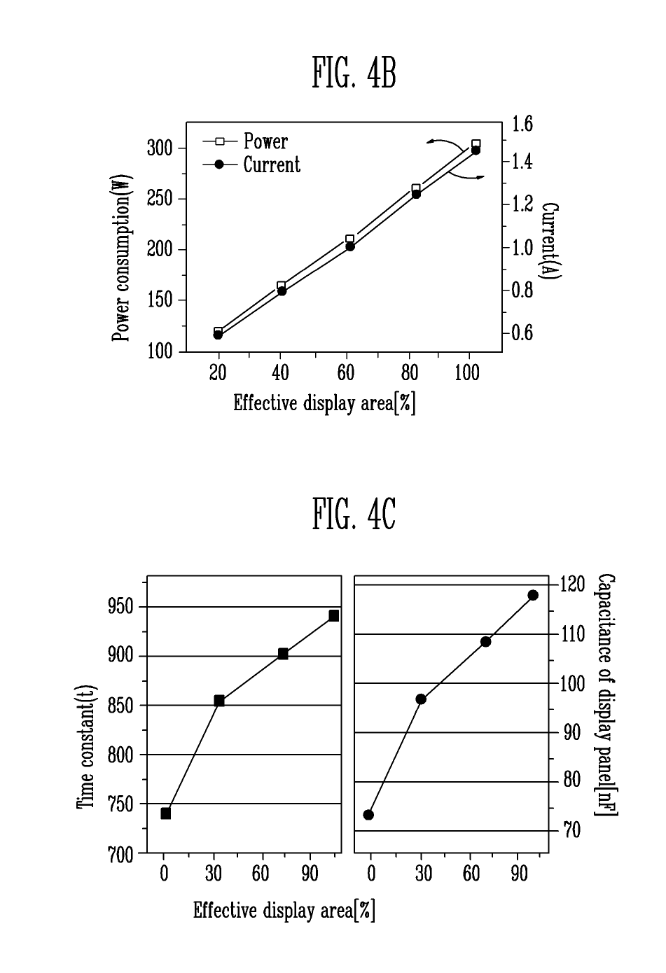

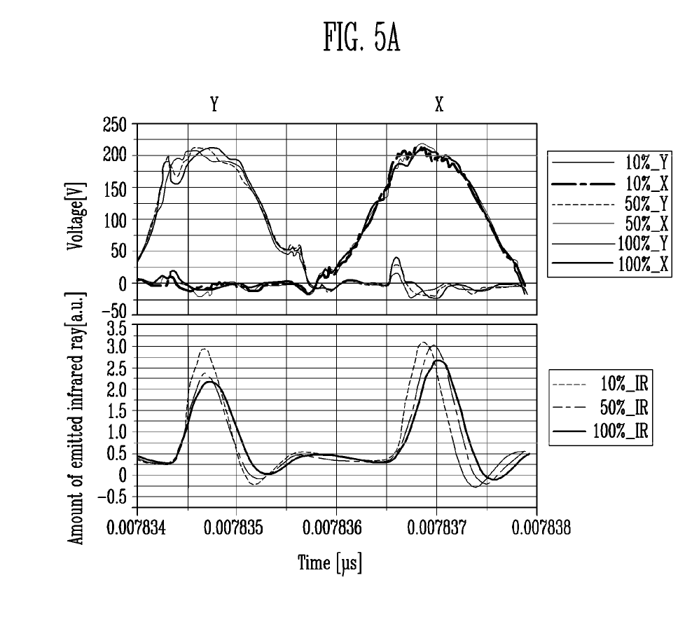

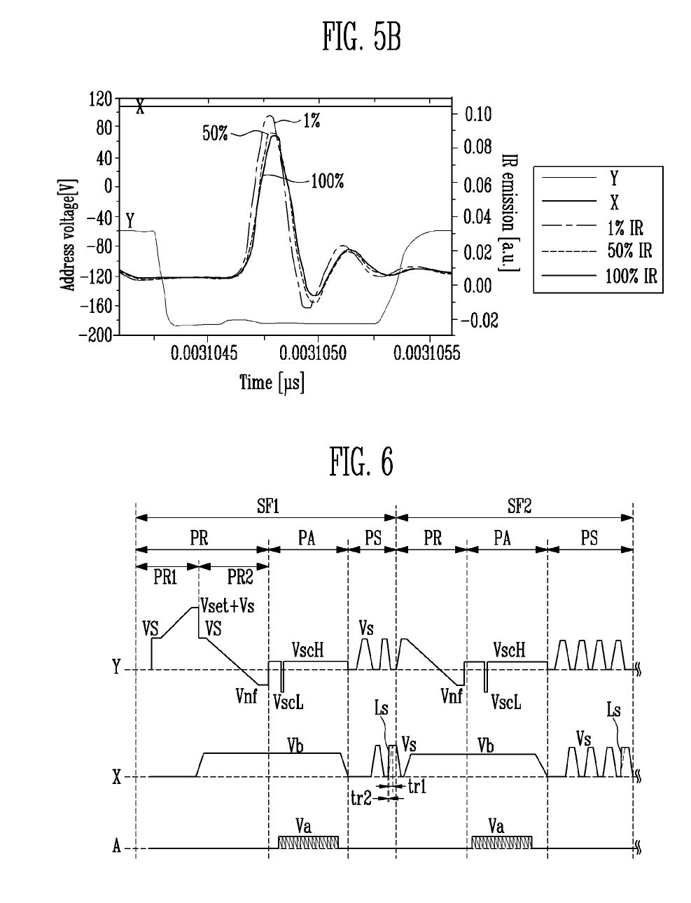

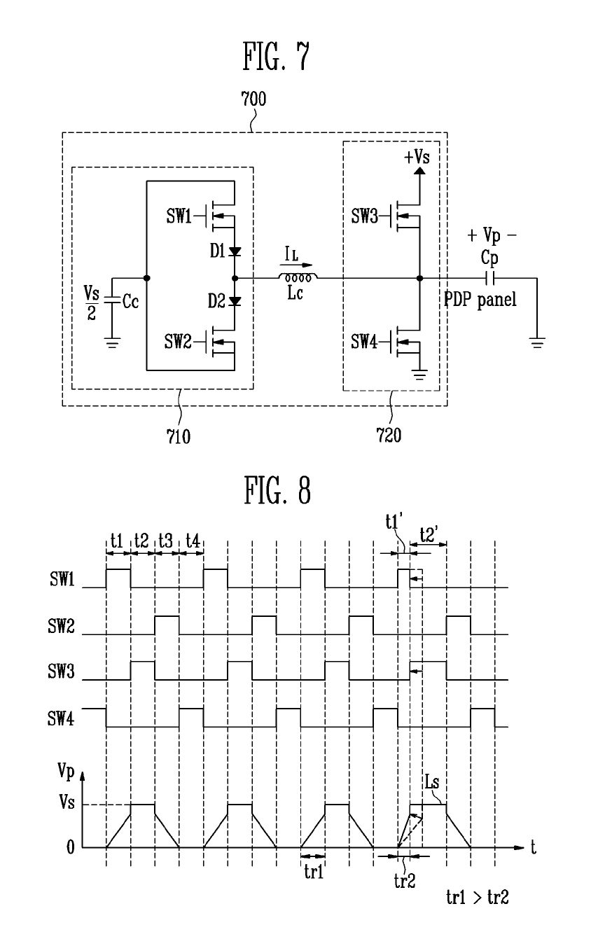

However, in the selective reset method, although the auxiliary reset pulses effectively rearrange the wall charges accumulated on the X-electrodes and the Y-electrodes, the wall charges of the A-electrodes is maintained as a state almost similar as the previous state. Therefore, when the distortion of the sustain pulses occurs due to the increase of load caused by the increase of the effective display area in the previous subfield, the sufficient discharge does not occur for the sustain period so that a shortage state of the wall charges on the A-electrodes remain until the next subfield. Due to this, the address signal may be delayed. When the address signal is delayed, since a desired discharge does not occur for the address period, the accumulated wall charges required to be supplied to the address may be short. Therefore, even for the following sustain period, the sufficient discharge does not occur, and as the result, there may be a problem displaying uniform gray such that brightness is displayed low. The problem will be described in detail with reference to FIGS. 4A to 5B later.

FIG. 4A is a view illustrating the increase of the effective display area of entire display area, FIG. 4B is a view illustrating variation of power consumption and current with the increase of the effective display area, and FIG. 4C is a view illustrating variation of a time constant and capacitance of the PDP with the increase of the effective display area.

Referring to FIGS. 4A to 4C, when a ratio of the effective display area of the entire display area increases, the power consumption and the current increase. Due to this, the time constant and the capacitance of the display panel increase.

Accordingly, when the capacitance of the display panel increases, an RC delay occurs in the display panel and the sustain pulses may be distorted.

When the sustain pulses are distorted, the amount of the wall charges may be changed due to the change of the amount of the discharge in the panel, particularly, the amount of the wall charges accumulated on the respective electrodes may be decreased when the sustain pulses are distorted by the RC delay. Due to this, actual brightness of an image may be lower than a target brightness in a subfield where the distortion of the sustain pulses occurs.

Moreover, when the sustain period, in which the sustain pulses are supplied, ends, a reset period of the next subfield starts. Although the wall charges of the X-electrodes and the Y-electrode are rearranged normally when the selective reset method is used, the wall charges of the A-electrodes remain short.

Therefore, the address signal is delayed for the following address period, and due to this, the distortion of the sustain pulses occurs again. The distortion of the sustain pulses occurs sequentially by the process for the following subfields, and the distortion of the sustain pulses may be more noticeable in the subfield of high gray. Due to this, the uniform gray cannot be displayed, and as a result, the quality of an image may deteriorate.

FIG. 5A is a view illustrating the amounts of the sustain pulses and infrared rays emitted from the X-electrodes and the Y-electrodes with ratios of the effective display area of 10%, 50%, and 100%, respectively.

Referring to FIG. 5A, the distortion of the sustain pulses is more noticeable with the increase of the ratio of the effective display area, and due to this, the amount of the emitted infrared rays decreases. Here, since the amount of the emitted infrared rays is equal to that of ultraviolet rays, the amount of the emitted infrared rays is measured so that a discharge amount of the display panel can be estimated. In other words, the discharge amount of the display panel decreases as the ratio of the effective display area increases.

FIG. 5B is a view illustrating the amount of the emitted infrared rays that is measured for the address period of one subfield.

Referring to FIG. 5B, in maintaining approximately 100 V of the X-electrode, the amount of the emitted infrared rays decreases with the increase of the ratio of the effective display area respectively by 1%, 50%, and 100% for the address period in which the address signal with approximately−(minus) 180 V is supplied to the Y-electrodes. While the ratio of the effective display area increases for the address period, the discharge amount of the display panel decreases so that the delay of the address signal occurs.

As described with reference to FIGS. 4A to 5B, when the ratio of the effective display area increases, the address signal is delayed. As such, when the address signal is delayed, the uniform gray cannot be displayed, thus deteriorating the quality of an image.

Therefore, a method of compensating the delay of the address signal and of applying the selective reset method will be proposed in the following embodiment of the present invention.

FIG. 6 is a view illustrating the driving pulses supplied to the respective electrodes of the PDP according to another method of driving a plasma display device. For convenience of explanation, the description for the same parts of FIG. 6 as those of FIG. 3 will be omitted.

Referring to FIG. 6, according to the method of driving a plasma display device of another embodiment of the present invention, an increasing time tr2 of the last sustain pulses LS that are supplied for sustain periods of the respective subfields SF is shorter than an increasing time tr1 of other sustain pulses.

Here, the increasing time tr of the sustain pulses is an important factor in determining the sustain discharge and the amount of the wall charges. In more detail, when the increasing time tr of the sustain pulses is relatively short, a discharge starting time is earlier and strong discharge occurs, increasing the wall charges to be accumulated in the discharge cells.

Therefore, when the increasing time tr2 of the last sustain pulses LS is shortened, the strong discharge supplements the wall charges that are short due to the distortion of the sustain pulses.

By doing so, even after the end of the respective subfields SF, the low discharge caused by the decreased amount of the wall charges can be prevented and the delay of the address signal that may occur by employing the selective reset method can be also prevented.

As described above, according to the other method of driving a plasma display device of the present invention, shortening the increasing time tr of the sustain pulses including the last sustain pulse LS causes the strong discharge, thereby preventing the delay of the address signal caused by the distortion of the sustain pulses. By doing so, the decrease of the brightness of an image, as the effective display area increases, can be prevented.

On the other hand, the shortening of the increasing time, causing the strong discharge, is not limited to the last sustain pulses LS of the respective sustain periods but may also be applied to several sustain pulses, including the last sustain pulse LS.

Here, the amount of the wall charges is effectively supplemented as the number of sustain pulses whose increasing slope is increased by shortening the increasing time, preventing the delay of the address signal. However, since the power consumption may be increased by the strong discharge, it is preferred to consider both of the two factors when determining the number of sustain pulses whose increasing time tr is decreased.

For example, the number of sustain pulses may be determined such that increasing time tr of one to four sustain pulses including the last sustain pulse LS to be sequentially supplied is minimized. However, for convenience of explanation, hereinafter the number of sustain pulses will be described to adjust the increasing time tr2 of the last sustain pulse LS.

The increasing time tr of the sustain pulses adjusted as described above may be determined by the controller 200 of FIG. 2 by considering the ratio of the effective display area.

In other words, the controller 200 estimates the ratio of the effective display area corresponding to an image signal, and controls whether the increasing time tr2 of the last sustain pulse LS and a degree of the adjustment based on the estimated ratio, and then supplies the same as control signals Sx and SY to the scan electrode driving unit 400 and/or the sustain electrode driving unit 500.

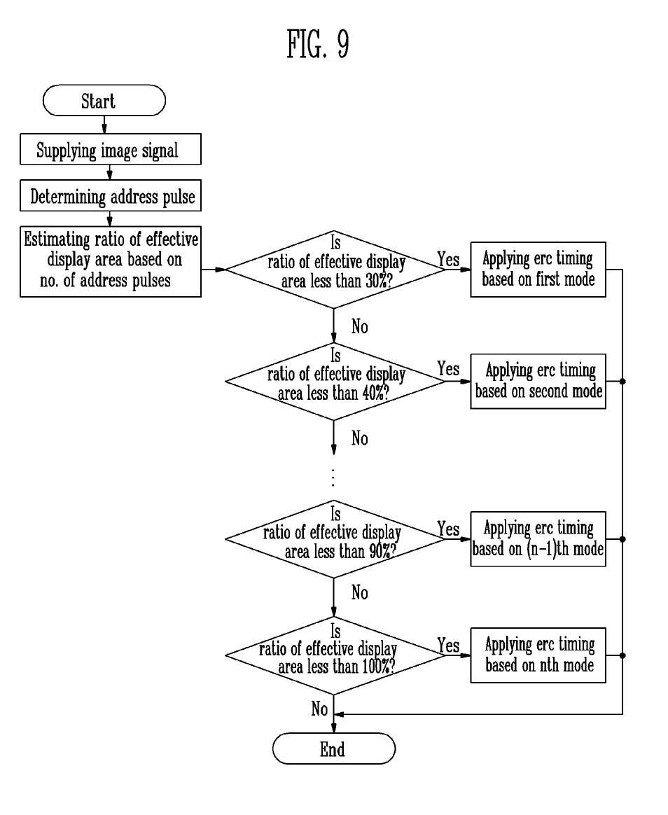

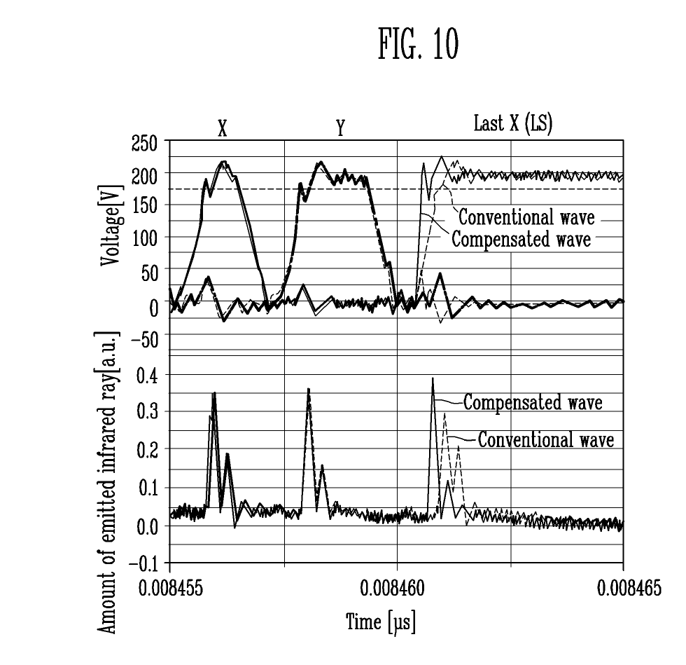

Then, switching timings of sustain discharging circuits ERC respectively included in the scan electrode driving unit 400 and/or the sustain electrode driving unit 500 are adjusted so that the increasing time tr2 of the last sustain pulse LS is adjusted. The operation of the sustain discharging circuits ERC will be described with reference to FIGS. 7 and 8.

FIG. 7 is a view illustrating an example of the sustain discharging circuits. FIG. 8 is a view illustrating driving waveforms for driving the sustain discharging circuit of FIG. 7 according to another embodiment of the present invention.

Referring to FIGS. 7 and 8, the sustain discharging circuit (or energy recovery circuit) 700 includes an energy recovering unit 710 having first and second switches SW1 and SW2, first and second diodes D1 and D2, and an energy recovery capacitor Cc. The sustain discharging circuit 700 also includes a sustain discharging unit 720 having third and fourth switches SW3 and SW4 coupled with each other in series, and an inductor Lc coupled between the diodes D1 and D2 of the power recovering unit 710 and the switches SW3 and SW4 of the sustain discharging unit 720 such that a load having a capacitor Cp of the PDP is coupled with the sustain discharging unit 720.

The sustain discharging circuit 700, as illustrated in FIG. 8, is driven by driving signals of the switches SW1 to SW4.

In more detail, in an initializing state, since the fourth switch SW4 is closed directly before the first switch SW1 is closed, a voltage Vp between both ends of the panel maintains 0 (zero) volts. At this time, the power recovery capacitor Cc is charged by a voltage Vs/2 which is as much as 1.2 times that of an external applied voltage Vs and prevents an inrush current at the beginning of the sustain discharge.

While maintaining the voltage Vp of the ends of the panel at 0 (zero) V, the first switch SW1 is turned on and is maintained in the turn-on state for a period t1.

During the period t1, an LC resonance circuit is formed by a loop of the power recovery capacitor Cc, the first switch SW1, the first diode D1, the inductor Lc, and the capacitor Cp of the PDP. Due to this, current flows in the inductor Lc and an output voltage Vp of the PDP panel increases.

At this time, the current I_{L} flowing through the inductor Lc is gradually decreased and finally becomes 0 (zero) by parasitic resistance and the output voltage Vp of the panel becomes the external applied voltage Vs.

After that, when the third switch SW3 is turned on for the period t2, since the external applied voltage Vs is supplied to the panel capacitor Cp through the third switch SW3, the output voltage Vp of the panel is maintained at a voltage level of the external applied voltage Vs.

After that, when the second switch SW2 is turned on for the period t3, an LC resonance circuit is formed. The LC resonance circuit includes the panel capacitor Cp, the inductor Lc, the second diode D2, the second switch SW2, and the power recovery capacitor Cc. This circuit allows the current to flow through the inductor Lc and onto the sustain discharging unit 720. Due to this, the output voltage Vp of the panel is gradually decreased and becomes 0 (zero), and the current flowing through the LC resonance circuit also becomes 0 (zero).

After that, when the fourth switch SW4 is turned on for the period t4, the output voltage Vp of the panel remains at 0V.

When the first switch SW1 is closed again, the cycle is repeated by the above-mentioned operation and a plurality of sustain pulses are generated.

However, in an aspect of the present invention, timings of the driving signal of the first switch SW1 and the third switch SW3 for generating the last sustain pulse LS among the switching signals for driving the sustain discharging circuit 700 are properly adjusted to control the discharge amount.

In more detail, an off-time of the driving signal of the first switch SW1 is made earlier such that time where the first switch SW1 is turned on is decreased from t1 to t1′. Moreover, the on-time of the driving signal of the third switch SW3 is made earlier by decreasing a width of the driving signal of the first switch SW1 such that the time when the third switch SW3 is turned on is increased from t2 to t2′.

By doing so, the increasing time tr2 of the last sustain pulse LS is shorter than the increasing time tr1 of the rest of the sustain pulses so that the strong discharge occurs in the PDP. Due to this, more wall charges are accumulated in the PDP and the delay of the address signal can be prevented.

As described above, according to an aspect of the present invention, the switching timing of the sustain discharging circuit 700 is adjusted such that the duration of the switching pulse (driving signal of the first switch SW1) supplied for the ascending period of the last sustain pulse LS is shorter than a duration of the rest of the switching pulses supplied for the ascending periods of the rest of the sustain pulses. By doing so, the strong discharge to compensate for the short wall charged by a relative simple method without manufacturing a specific driving board so that the delay of the address signal can be prevented.

FIG. 9 is a flowchart illustrating the method of driving a plasma display device according to another embodiment of the present invention. Hereinafter, a method of determining the increasing time of the sustain pulses will be described in detail by referring to FIG. 9 with FIG. 2.

Referring to FIG. 9, the method of driving a plasma display device according to another embodiment of the present invention includes supplying an image signal, determining an address pulse corresponding to the image signal, estimating a ratio of an effective display area based on the number of address pulses, and adjusting a driving timing of a sustain discharging circuit (hereinafter, referred to as ERC) in correspondence to the ratio of the effective display area. Here, the driving timing of the ERC is controlled by a driving timing signal generated by the controller 200.

In more detail, the image signal is supplied from the outside to the controller 200.

Then, the controller 200 receiving the image signal determines the address pulses based on the image signal and estimates the ratio of the effective display area corresponding to the number of the address pulses.

After that, the controller 200 compares the estimated ratio of the effective display area with a reference ratio of the effective display area and selects a proper mode for driving the timing of the ERC 700 in order to generate the last sustain driving waveform matching with the respective ratios of the effective display area from predetermined modes.

The controller 200 generates a driving timing signal for applying the selected mode as the driving timings of the ERC 700 included in the scan electrode driving unit 400 and/or the sustain electrode driving unit 500.

That is, the controller 200 generates the scan electrode driving control signal SY and/or the sustain electrode driving control signal SX having driving timing signals corresponding to the selected mode, and supplies the same to the scan electrode driving unit 400 and/or the sustain electrode driving unit 500 respectively.

Here, as the ratio of the effective display area increases, the capacitance of the panel also increases and the delay of the address signal may be more noticeable. Therefore, it is preferable to set a mode corresponding to a relative effective display area such that the increasing time tr2 of the last sustain pulse LS is further decreased. To this end, in the driving timing signal, a pulse width of the driving signal of the first switch SW1 is set to be short such that the increasing time tr2 of the last sustain pulse LS is decreased with the increase of the ratio of the effective display area.

For example, when the ratio of the effective display area is less than 30%, an ERC timing is applied according to the first mode which does not change the increasing time tr2 of the last sustain pulse LS (that is, the increasing time tr2 of the last sustain pulse LS is set to be identical to the increasing time tr1 of the rest of the sustain pulses LS), so that the scan electrode driving control signal SY and/or the sustain electrode driving control signal SX can be generated.

When the ratio of the effective display area exceeds 30% and is less than 40%, an ERC timing is applied according to the second mode of determining the increasing time tr2 of the last sustain pulse LS to be shorter than the increasing time tr1 of another sustain pulses, so that the scan electrode driving control signal SY and/or the sustain electrode driving control signal SX can be generated.

An ERC timing is applied according to an increase in a difference from the increasing time tr1 of another sustain pulses as the ratio of the effective display area is increased by the above-mentioned method. That is, the ERC timing for shortening the increasing time tr2 of the last sustain pulse LS is applied to generate the scan electrode driving control signal SY and/or the sustain electrode driving control signal SX.

The sustain pulses are generated in response to the scan electrode driving control signal SY and/or the sustain electrode driving control signal SX.

As described above, according to an aspect of the present invention, the increasing time tr2 of the last sustain pulse LS is properly adjusted in comparison to the ratio of the effective display area. Therefore, the delay of the address signals caused by the increase of the effective display area can be prevented and the uniform gray scale is improved, thereby improving the quality of an image.

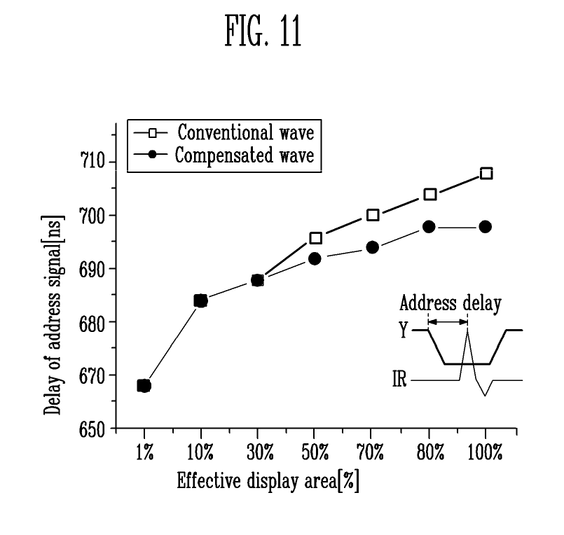

FIG. 10 is a view illustrating the amount of emitted infrared rays based on the adjustment of the increasing time of the last sustain pulse.

Referring to FIG. 10, when the last pulse Last X of the X-electrodes, that is, the increasing time of the last sustain pulse LS is not adjusted, the amount of the emitted infrared rays is decreased. If the increasing time of the last sustain pulse LS is not adjusted, the discharged amount of the panel increases and a relative small amount of the wall charges is generated.

On the contrary, when the increasing time of the last sustain pulse LS is shortened, the decrease of the emitted infrared rays is prevented. Due to this adjustment, the strong discharge occurs in the panel and the wall charges are compensated.

FIG. 11 is a view illustrating the delay of the address signals, based on the ratio of the effective display area according to the adjustment of the increasing time of the last sustain pulse.

Referring to FIG. 11, when overall delay of the address signals increases as the effective display area increases, the increasing time of the last sustain pulse LS is adjusted (that is, the increasing time of the last sustain pulse is decreased), the delay of the address signals is decreased in comparison to the state prior to the adjustment.

As such, according to another aspect of the present invention, the driving timing of the sustain discharging circuit is adjusted to decrease the increasing time of at least one sustain pulse including the last sustain pulse. Due to this adjustment, the strong discharge occurs in the display panel so that the amount of the wall charges which are shortened by the distortion of the sustain pulses can be compensated.

Therefore, the delay of the address signals is prevented, the uniform gray scale can be achieved in the display panel, and the image quality can be improved.

Although exemplary embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A plasma display device driving method of driving a single frame of the plasma display device, the single frame divided into a plurality of subfields, each subfield including a reset period, an address period, and a sustain period, the method comprising:
shortening an increasing time of at least one sustain pulse including a last sustain pulse among a plurality of sustain pulses, to be supplied at the sustain period of the plurality of subfields, than an increasing time of the remaining sustain pulses.

2. The plasma display device driving method as claimed in claim 1, wherein a main reset pulse, including a reset ascending period and a reset descending period, is supplied during the reset period of a first subfield, and
an auxiliary reset pulse, having a maximum voltage level lower than a maximum voltage level of the main reset pulse, is supplied to at least one reset period of the remaining subfields.

3. The plasma display device driving method as claimed in claim 1, wherein the increasing time of the at least one sustain pulse including the last sustain pulse is adjusted by adjusting a switching timing of a sustain discharging circuit.

4. The plasma display device driving method as claimed in claim 3, wherein the switching timing is set such that a duration of a switching pulse to be supplied to an ascending period of the last sustain pulse is shorter than a duration of a switching pulse to be supplied to an ascending period of the remaining sustain pulses.

5. The plasma display device driving method as claimed in claim 1, wherein the last sustain pulse whose increasing time decreases comprises one to four sustain pulses to be sequentially supplied.

6. A method of driving a plasma display device comprising:
determining an address pulse in response to an image signal;
estimating a ratio of an effective display area corresponding to the address pulse;
controlling a driving timing signal of a sustain discharging circuit for generating the sustain pulse based on the ratio of the effective display area; and
generating the sustain pulse in response to the driving timing signal;
wherein the driving timing signal is controlled to shorten an increasing time of at least one sustain pulse including the last sustain pulse to be supplied to the sustain period of respective subfields of a single frame of the plasma display device as the ratio of the effective display area increases.

7. The method of driving a plasma display device as claimed in claim 6, wherein the controlling of the driving timing signal of the sustain discharging circuit comprises:
selecting at least one mode among predetermined modes by comparing the estimated ratio of the effective display area with a reference ratio of the effective display area; and
generating the driving timing signal of the sustain discharging circuit based on the selected mode.

8. The method of driving a plasma display device as claimed in claim 7, wherein the driving timing signal of the sustain discharging circuit comprises a switching pulse for controlling turning on/off a plurality of switches included in the sustain discharging circuit.

9. The method of driving a plasma display device as claimed in claim 8, wherein a duration of the switching pulse of the sustain discharging circuit to be supplied to the ascending period of the at least one sustain pulse including the last sustain pulse is set to be short at a mode where the ratio of the effective display area corresponds to a relative large value, among the modes.

10. The method of driving a plasma display device as claimed in claim 6, wherein the sustain pulse including the last sustain pulse whose increasing time decreases comprises one to four sustain pulses to be sequentially supplied.

11. The method of driving a plasma display device as claimed in claim 6, wherein the ratio of the effective display area is estimated based on the number of the address pulse.

12. A plasma display device comprising:
a plasma display panel including discharge cells formed at crossings of address electrodes, scan electrodes, and sustain electrodes;
a driving unit for driving the address electrodes, the scan electrodes, and the sustain electrodes; and
a controller for supplying a control signal to the driving unit in response to an image signal supplied from outside, wherein the controller estimates a ratio of an effective display area of an entire display area of the plasma display panel in response to the image signal and generates a control signal for controlling sustain pulses, generated by the driving unit, to be adjusted in response to the ratio of the effective display area.

13. The plasma display device as claimed in claim 12, wherein the control signal is controlled to decrease an increasing time of at least one sustain pulse including the last sustain pulse of subfields of a frame of the plasma display device, among sustain pulses generated by the driving unit as the ratio of the effective display area increases.

14. The plasma display device as claimed in claim 13, wherein the sustain pulse including the last sustain pulse whose increasing time decreases comprises one to four sustain pulses to be sequentially supplied.

15. The plasma display device as claimed in claim 12, wherein the driving unit comprises:
an address electrode driving unit for driving the address electrodes;
a scan electrode driving unit for driving the scan electrodes; and
a sustain electrode driving unit for driving the sustain electrodes; and
the scan electrode driving unit or the sustain electrode driving unit comprises a sustain discharging circuit whose driving timing is adjusted by the control signal.

16. The plasma display device as claimed in claim 15, wherein the driving timing of the sustain discharging circuit is controlled to decrease a duration of pulses to be supplied to an ascending period of at least one sustain pulse including the last sustain pulse among sustain pulses generated for the sustain period of the respective subfields as the ratio of the effective display area increases.
